(19) United States
(12) Patent Application Publication
(10) Pub. No.: US 2023/0208186 A1
(43) Pub. Date: Jun. 29, 2023

(54) HYBRID POWER CUBE

(71) Applicant: KZ ENERJI COZUMLERI VE DIS TICARET LIMITED SIRKETI, Cekmekoy, Istanbul (TR)

(72) Inventor: Korhan TOPALOGLU, Cekmekoy, Istanbul (TR)

(21) Appl. No.: 18/000,620

(22) PCT Filed: Nov. 19, 2021
(86) PCT No.: PCT/TR2021/051241

§ 371 Date: Dec. 2, 2022

(30) Foreign Application Priority Data
Dec. 18, 2020 (TR) 2020/20888

(51) Int. Cl. H02J 9/06; H02B 1/48

(52) U.S. Cl. CPC H02J 9/062; H02B 1/48; H02J 7/35

(57) ABSTRACT

Disclosed is a hybrid power cube having at least one inverter and an analyzer which are connected to at least one solar energy source or other alternative energy sources, at least one generator, at least one mains energy and a battery, receives the electrical energy from the solar energy source and/or other alternative energy sources, generator, mains energy and battery according to the determined conditions, transmits the continuous and uninterrupted energy to the energy consumption center and contains the necessary energy optimization software.

### SUBJECT OF THE INVENTION AND TECHNICAL FIELD

This invention relates to a hybrid power cube device that has multiple electricity generation and distribution functions and provides an uninterrupted energy. The invention relates to a hybrid power cube device that produces the electricity from the solar energy and wind energy, stores it, performs the most appropriate optimization of the energy need according to the determined criteria, and supplies it to the system uninterruptedly.

### STATE OF THE ART

Immediately after the introduction of the electrical energy into the world history, the generators have been activated in order to eliminate the power cut and ensure the continuity of the energy. The generator is a machine that consists of an alternator converting the electrical energy into the mechanical energy, and an engine. The history of the generators used today dates back to 1831. A very simple apparatus created by a British scientist, physicist and chemist Michael Faraday is the first example of today's generator. In terms of providing uninterrupted energy, generators are of great importance in homes, workplaces, industry and many other areas. The generators are divided into types according to their usage areas. The generators take their technical final shape in line with the demands of the users and the scale of the project. The generator types are divided into diesel generators, gasoline generators, natural gas generators and LPG generators according to the fuel type. In continuous load supply, the generator is used as the primary load supply source. They are generally used in areas such as mining, construction sites, and the shipping industry. Apart from these applications, the load is fed only by the generators in applications where the demand power relatively increases.

In the state of the art, the generators are used as a backup power source and as a backup source when the mains is interrupted in places where a mains is available. They are produced with trailers and wheels for mobile use in various models, and they provide electrical energy by being transported to the place where the energy is needed.

They have a towable structure on the road with a tow tractor and are usually low-powered. The portable type ones are usually produced at around 10 kVA to 12 kVA. These types of generators are mostly air-cooled models suitable for use in homes, gardens, and mobile working environments. They are not relatively heavy and have a portable structure. On the other hand, said generators are not capable of feeding a system by themselves, and they are no longer economical in such use. The generators specified in the state of the art produce single-function instantaneous energy, feed the system temporarily, and do not store any electricity. In addition, since they use the conventional energy sources, they have increased their carbon footprint and have started to be no longer eco-friendly.

In the state of the art, the generators that are automatically activated in case of power failure are available. Even, it is seen that the systems integrated with the alternative energy sources and called “hybrid generators” have been put on the market in recent years. The hybrid generator systems generally operate as an uninterrupted energy source consisting of a two-cycle diesel engine, a DC alternator, photovoltaic panels, a wind turbine, and an accumulator bank and operating at DC nominal voltage (usually 48 V). In said hybrid generators, when the solar and wind energy is insufficient, the accumulator bank feeds the load as discharge and the continuity of the energy is ensured. As such, the hybrid generators are highly efficient and innovative products. However, it is seen that there are some technical problems in the operation and continuity of these systems. First of all, there is a need for personnel in order to put the system into use and ensure its continuity, which requires technical knowledge. That is, the current hybrid generators are not the systems where the immediately required connections can be made easily by non-experts and the adjustments are sustainable, as it is known in the market as “plug-and-run”. The technical experts are needed to activate the majority of the hybrid generators known in the market, as well as the intervention of an expert technical personnel is also needed to change the energy supply needs.

A document encountered in the state of the art is the Russian patent numbered RU2712321. In said document, the production of the electrical energy as a result of burning biogas obtained from a waste tank is mentioned. It is believed that the alternative energy sources cannot be integrated with our invention as the energy source is of one type.

Another document encountered in the state of the art is the Japanese patent numbered JP1996186931. In said document, a cogeneration power generation device makes heat recovery and this cogeneration power generation device is also integrated with solar panels. However, since there is no energy storage, it is mainly thought that there is no hybrid model.

Another document encountered in the state of the art is the American patent numbered US20090062969. In said document, a mathematical energy modeling system of a hybrid energy generation model is mentioned. Since there is no product, it is understood that the invention is only about the method in theory.

Another document encountered in the state of the art is the American patent numbered US20160352116. In said patent, a study on modeling and managing the energy storage and loading optimization processes of a hybrid system is mentioned. It is mainly thought that it does not cover the subject of the invention.

Another document encountered in the state of the art is the European patent numbered EP2955807. In said patent, it is seen that a system and method related to the regulation of the energy coming from the different alternative energy sources are basically mentioned. It is widely believed that the invention of the patent can be used in areas such as energy fields.

A document examined in the state of the art is the international patent application numbered WO2014146103. A hybrid generator is mentioned in said patent. In the feature of the invention mentioned in this patent, a hybrid generator is mentioned, that optimizes especially situations such as the recovery of waste heat generated in the generator or the operation in an idle state and is supported by the accumulator systems, in order to increase the efficiency of the generator producing the energy.

Another document examined in the state of the art is the international patent numbered WO2017031586. In said patent, the energy taken from the renewable energy sources such as the solar or wind energy, a lighting system supported by the accumulators and generators is mentioned.

In the state of the art, there are the systems developed to ensure the continuity of the energy taken from a large number of the hybrid generators or similar different energy sources. However, in the researches, a system that optimizes the continuity of the energy in the form of a single cube or package, by making the relevant connections easily by the user without a high technical knowledge, has not been found.

### TECHNICAL PROBLEMS AIMED BY THE INVENTION TO BE SOLVED

With the hybrid power cube of the invention, a system that can be easily connected to the renewable energy sources, accumulator or battery systems, fossil fuel generators, and mains energies, and allows the required energy to be provided continuously (without any interruption) with said connection is aimed. Said system is a package system that optimizes the supply and use of the energy.

An advantage of the hybrid power cube of the invention is that it is a package product that can be easily connected to the system and activated in the power cuts, in the areas where the mains electricity is frequently interrupted, in micro mains, in field services, in the areas where the uninterrupted power is needed and in many other areas. The invention offers wide possibilities by improving the product range used as the energy supply source in the conventional generators. In this way, the mobility of the product has increased, and it can ensure the uninterrupted operation thereof in the areas such as the field services, as well as in fuel supply processes. It aims to consistently provide the uninterrupted power needs of the users by using more than one product and process without being dependent on one product (the energy source). Another advantage of the hybrid power cube of the invention is that it can generate the electricity by using gasoline, diesel, or gas with the generator to which it is connected and store the energy taken therefrom. The battery system in the hybrid power cube converts and stores the energy coming from the solar panels (or the alternative energy sources such as the wind or hydro energy), and when necessary, can bypass the storage and transmit it directly to the system. In this way, when the fuel required for the generator is not enough, it transforms the energy it receives from the sun and gives it directly to the system or provides the energy to the system by means of the energy stored in the batteries.

Another advantage of the hybrid power cube of the invention is that the hybrid power cube accommodates many systems that the ordinary generators or hybrid generators do not have. First of all, the connection sockets or inputs-outputs for the easy connection, and most importantly, the software-installed inverters that provide the necessary energy optimization make the system superior to the known state of the art.

Another advantage of the hybrid power cube of the invention is that it stores energy at high rates thanks to the batteries it has. The storage of the energy in the battery prevents the system from being de-energized in the case that the energy supplied from one or several points is interrupted. Therefore, the continuous (without interruption) energy can be provided.

Another advantage of the hybrid power cube of the invention is a smart micro main as well as its electronic elements. Thanks to the software contained in the inverter, whichever energy is suitable for the system, it can be given to the system by optimizing it economically and technically. In this regard, the hybrid power cube is also an excellent optimization tool. If the software that provides this optimization is desired, it is also possible to provide it precisely not in the inverter, but with PLC systems or directly with computer systems containing processors.

Another advantage of the hybrid power cube of the invention is that it can be put at the service of the user with the simplest interface. Therefore, it is aimed that the users can use it easily without requiring any technical training. The easy adjustment of the system and the easy connection of the energy source turn the system into a package or cube known as “plug and run” in the market.

Another advantage of the hybrid power cube of the invention is that the system has also a structure that allows the generated energy to be returned to the mains or other desired areas (other consumption areas).

Pictures that will facilitate the understanding of the hybrid power cube of the invention are given below.

### DESCRIPTION OF THE DRAWINGS

FIG. 1 is the schematic picture showing the location of the hybrid power cube of the invention in an energy system.

FIG. 2 is the picture showing the side and perspective views of the hybrid power cube of the invention.

FIG. 3 is the detailed picture showing the control and connection parts of the hybrid power cube of the invention.

FIG. 4 is the perspective exploded or sectional picture of the hybrid power cube of the invention.

FIG. 5 is the schematic picture of the hybrid power cube of the invention, showing the inverter connections.

FIG. 6 is the process flowchart showing the operating system of the hybrid power cube of the invention.

### REFERENCE NUMERALS OF THE PARTS AND SECTIONS TO SERVE FOR THE DISCLOSURE OF THE INVENTION

1—Hybrid power cube
2—Solar energy source
3—Generator
4—Wind energy source
5—Mains energy
6—Energy consumption center
7—Battery
8—Inverter
9—Analyzer
10—Front cover
11—Fan group
12—Monitoring window
13—Mains input socket
14—Generator input socket
15—Mains input fuse
16—Generator input fuse
17—Solar energy positive input
19—Solar energy negative input
19—Main accumulator braker
20—Main power output socket—3 phase
21—Power output fuse—3 phase
22—Power output fuse—1 phase
23—Main power output—1 phase
24—Generator start socket

### Process Flow Charts to Serve for Describing the Invention

100—Making all connections
200—Activating the second primary energy source in case of decrease or cut-off of the first primary energy source defined or determined by the user.
300—Controlling the system while the second primary energy source is active and if possible, activating the first primary energy source, if not ensuring the energy continuity with the second primary energy source.
400—In the case that the second primary energy source is decreased or cut off, activating the next appropriate energy source.
500—Controlling the system while the next primary energy source is active and if possible, activating the first primary energy source, if not, ensuring the energy continuity with the second primary energy source and activating the next energy source or battery if the second primary energy source is not possible.
600—Controlling the system while the next primary energy source is active and providing the uninterrupted energy to the system by activating the most appropriate energy source.

### DETAILED DESCRIPTION OF THE INVENTION

The invention offers solutions in every field where the uninterrupted energy is needed, and it is related to a hybrid device that has more than one electricity generation and distribution function in its structure and that provides an optimum energy continuity according to the conditions determined among them. The invention consists of a hybrid structure that produces and stores the electricity from petroleum products, the solar energy, the wind energy, or other renewable energy generation sources simultaneously or alternatively, and can feed the system by making the most appropriate optimization of the energy needed. The invention may vary depending on the technical specifications in many dimensions and on a project basis. Therefore, the patent right should not be limited to certain patterns or sizes. The illustrations used in the invention are given only to facilitate the understanding of the invention. It should not be obligatory.

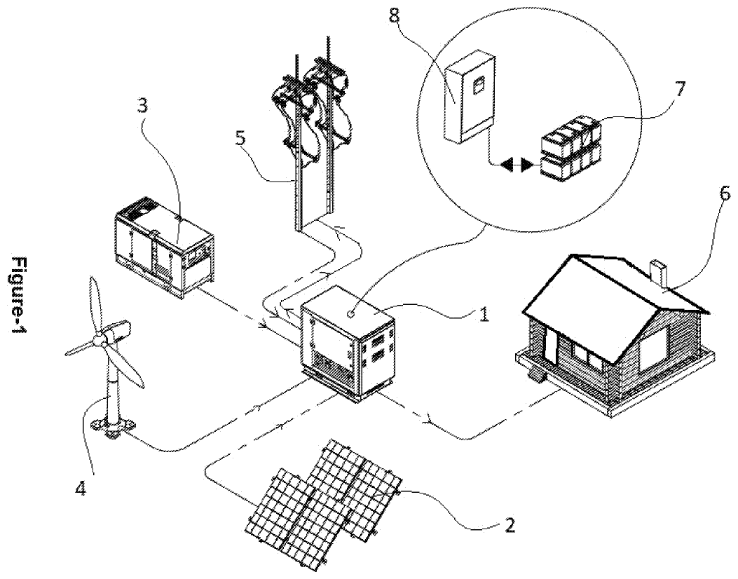

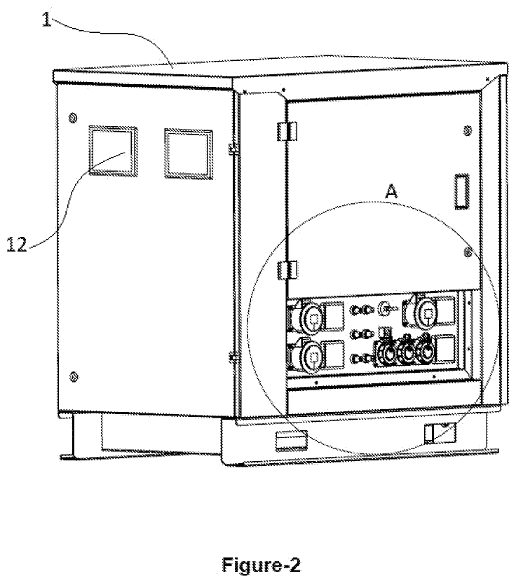

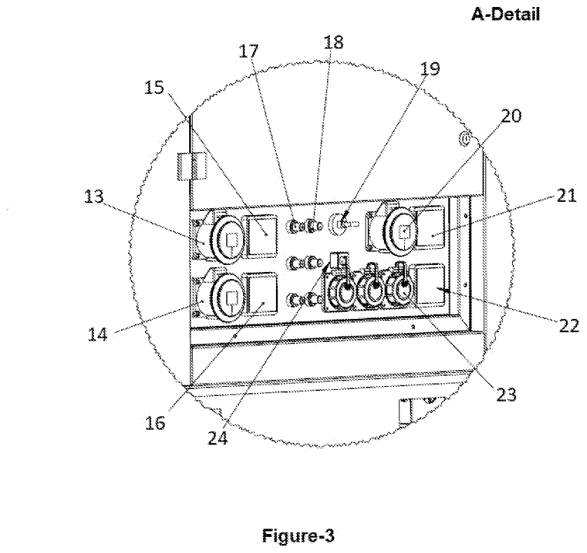

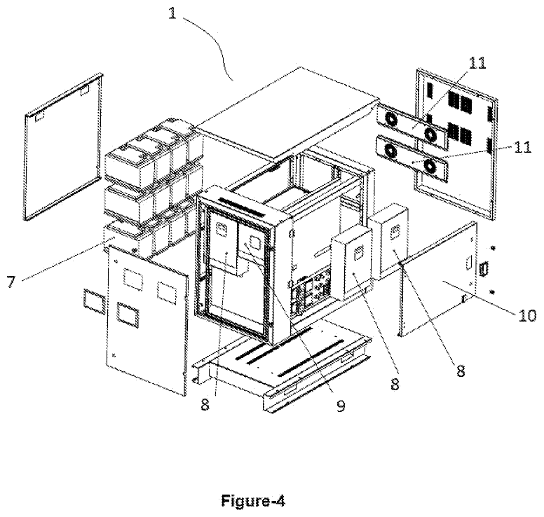

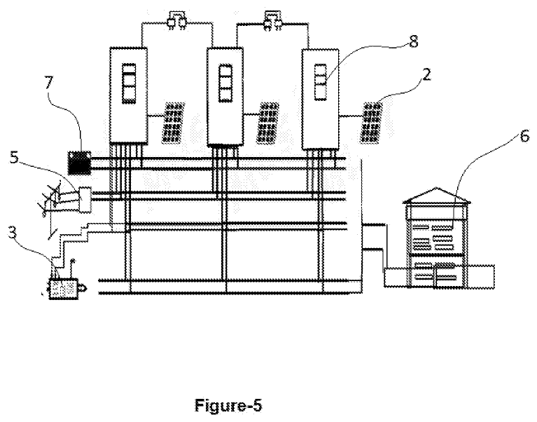

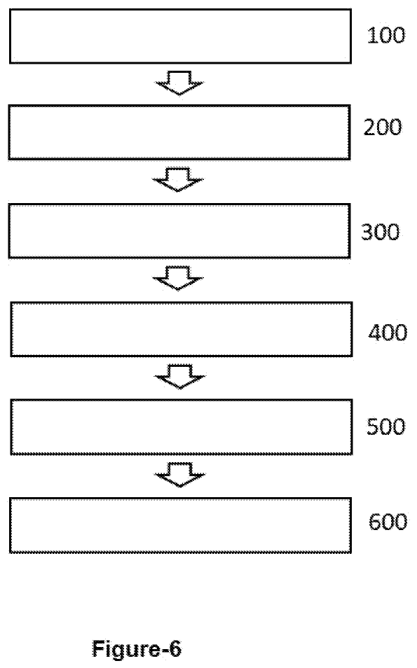

The hybrid power cube of the invention is the picture that schematically shows which energy sources and which type of energy receivers or energy consumption centers (such as a house, factory) are used in FIG. 1. FIG. 2 shows a perspective view of the hybrid power cube and FIG. 3 shows the view of the panel that enables the hybrid power cube of the invention to be practically integrated into the system in a “plug-and-run” manner. FIG. 4 shows the perspective exploded or sectional picture of the hybrid power cube of the invention. FIG. 5 shows the general connection of the system schematically. FIG. 6 shows the flowchart of the general operation of the system, which shows how the hybrid power cube of the invention provides the energy continuity by optimizing.

The hybrid power cube 1 of the invention most generally contains at least one inverter 8 and an analyzer 9 which are connected to at least one solar energy source 2 or other alternative energy sources, at least one generator 3, at least one mains energy 5 and battery 7, receives the electrical energy from said solar energy source 2 and/or other alternative energy sources, generator 3, mains energy 5 and battery 7 according to the determined conditions, transmits the continuous and uninterrupted energy to the energy consumption center 6 and contains the necessary energy optimization software. The elements that provide the hybrid power cube 1 of the invention with the energy are the solar energy source 2, the generator 3, the mains energy 5 and the battery 7. Here, instead of the solar energy source, the wind energy source 4 can be used as an alternative source or together. Here again, other renewable energy sources can be used together or as an alternative to each other. The generator 3 may be a generator using the petroleum-based fuel in the state of the art, or it may be the generators working with biodiesel or other systems. The battery 7 contained in the hybrid power cube 1 of the invention is used not only to supply the electrical energy to the system, but also to store the energy if the solar energy source 2 and other energy sources used in the system are sufficient. That is, the battery 7 is used both to store the energy and to provide a continuous and uninterrupted transition in energy preferences. In the hybrid power cube 1 of the invention, the inverter 8 that provides the main function of the invention is an energy converter and planner which includes the software therein.

Here, the planning means the supply of the energy according to the determined priorities and its continuous transmission to the relevant places without interruption. The planning of the use of the energy can be in predetermined sequences as well as in a structure that can be changed according to the user's preference. There can be at least one inverter 8 in the hybrid power cube 1 of the invention, but also in different numbers. For example, as seen in FIG. 5, three inverters or more inverters can be connected to each other in a synchronized manner and the flow of electrical energy can be regulated. In this case, there may be the inverters such as the first inverter, the second inverter, the third inverter, etc. On the other hand, instead of the inverter 8, a PLC system integrated into the system and containing the embedded software or, if necessary, a computer system containing at least one processor can be used to provide the energy optimization. The hybrid power cube 1 of the invention can provide the electrical energy to the energy consumption center 6 as seen in FIG. 1. In addition, there may be devices in the state of the art or devices that can be used in the light of new developments, performing a similar function instead of the inverter 8 that performs the energy conversion and optimization in the system. That is, the word “inverter” alone should not be obligatory. The fact that it is a device that converts the energy and provides the optimization is important. The term used as “inverter” should be understood broadly. Here, the energy consumption center 6 can be an environment where all kinds of energy are used, such as a house, building, workplace, mobile stations.

The hybrid power cube 1 of the invention also allows the safe integration of other systems with the inputs and outputs that it contains. As the system does not require technical expertise, it is possible to activate the system by simply making the connections, also known as “plug-and-run” in the market. The system settings can be made in advance or easily changed later, depending on geographical location, energy possibilities, or economic conditions. The hybrid power cube 1 of the invention contains the main accumulator breaker 19. The main accumulator breaker 19 prevents dangerous electric current from flowing from the battery 7 during the connection or technical work. The hybrid power cube 1 of the invention contains the mains input socket 13 to which the mains energy 6 is connected, the generator input socket 14 to which the energy taken from the generator 3 is connected, the solar energy positive input 17 to which the solar energy source 2 is connected, and the solar energy negative input 18 elements. Instead of the solar energy source 2, the wind energy source 4 can also be connected to the system. In this case, the connections will be compatible with it. Or, if desired, all alternative energy sources (solar, wind, water, etc.) can be connected to the system separately or as alternatives to each other. In this case, the input elements to the system will be arranged according to these energy sources. The hybrid power cube 1 of the invention includes a mains input fuse 15 at the mains input and a generator input fuse 16 at the generator input. The fuses here provide the energy security against the dangers that may occur in variable electric currents or high voltage. The hybrid power cube 1 of the invention contains the main power output socket—3 phase 20, main power output—1 phase 23, power output fuse—3 phase 21, and power output fuse—1 phase 22 elements which are connected to the energy consumption center 6. Only 1-phase and only 3-phase output can be applied in different models. The generator star socket 24 contained in the system is connected to the generator 3. There is a generator transfer panel in the system for automatic activation of the system. This detail did not need to be shown in the pictures. The mentioned structure allows the generator to be activated automatically with the control of the inverters 8, or manually if desired.

The hybrid power cube 1 of the invention can not be only used for taking the energy from the mains energy 5, generator 3, solar energy source 2, and/or other energy sources and transmitting it to the consumption center uninterruptedly, but also for returning the generated energy to the mains (or to another location). For this purpose, namely, to supply the energy to the mains or the relevant outdoor area, suitable equipment must be added. That is, the inputs and outputs, fuses and inverters must be hybrids such that they can work both ways, not single-sided. For example, the hybrid inverter or equivalent devices should be used instead of the inverter known as an on-mains inverter on the market.

The hybrid power cube 1 of the invention has at least one front cover 10 that allows the connections or adjustments to be made, at least one fan group 11 for cooling, and at least one monitoring window 12 which allows observing the inside of the cube or the indicators from the outside are included.

The hybrid power cube 1 as specified above receives the electrical energy from the different places through the inverters 8 and the software included in it and provides the energy continuously and uninterruptedly to places such as houses, workplaces, warehouses, buildings, mobile areas, which are the energy consumption centers 6. Here, the uninterrupted energy will undoubtedly be provided at a minimum cost or minimum effort. Therefore, the primary energy source will be the solar energy source 2 and/or the wind energy source 4 which is/are the alternative energy source(s). Then the mains energy 5 and the generator 3 may be the alternative energy sources. The battery 7 is basically used to provide the short-term energy during the power cuts. However, these batteries are not limited to a short time, they can also be used as a basic energy provider according to the battery capacity. On the other hand, in regions where oil or fuel is cheap, the generator 3 may be the main energy provider. Accordingly, in the planning of the system, the priority may be the renewable energy source such as a solar energy source 2, then the mains energy 5, then the generator 3, and the battery 7. However, this order is for example only. Generally accepted criteria is the determination of priorities according to the energy opportunities. As stated above, the solar energy source 2 has priority over the generator 3 in the countries in Turkey and Europe. That is, the system ranks the energy sources as the first primary energy source and the second primary energy source. The battery 7 can be the primary energy source in the first, second, or any stage, or it can also be an energy source that works as a buffer and ensures the continuity by running the system for a limited time. That is, in the system, there is an energy source grouping such as the first primary energy source, the second primary energy source, next primary energy source.

In regions where the solar energy is easy and cheap, the first primary energy source may be the solar energy source 2, and the second primary energy source may be the generator 3 or the mains energy source 5. The next energy source can be an alternative energy source, if available, or the battery 7. While the battery 7 is often the next energy source after the alternative energy source, it can sometimes be the last preferred energy source. Accordingly, the inverters 8 will operate the system according to a general logic rule for the uninterrupted energy after the hybrid power cube is connected with the most suitable energy sources, thanks to the software included in it. That is;
100—Making all connections
200—Activating the second primary energy source in case of decrease or cut-off of the first primary energy source defined or determined by the user.
300—Controlling the system while the second primary energy source is active and if possible, activating the first primary energy source, if not, ensuring the energy continuity with the second primary energy source.
400—In the case that the second primary energy source is decreased or cut off, activating the next appropriate energy source.
500—Controlling the system while the next primary energy source is active and if possible, activating the first primary energy source, if not ensuring the energy continuity with the second primary energy source and activating the next energy source or battery if the second primary energy source is not possible.
600—Controlling the system while the next primary energy source is active and providing the uninterrupted energy to the system by activating the most appropriate energy source.

This algorithm or flowchart described above is a general operation of the system. The stage and/or process details of this process are given below;

### Making all Connections 100

At this step, it is ensured that the hybrid power cube 1 is connected to all alternative energy sources, generator and mains and the system is started to operate as it receives the electrical energy from the first primary energy source. The battery 7 is in the cube in a connected state, or if necessary, it is positioned in a separate place and the connection is made. Here, the first primary energy source may be the solar energy source 2, alternative energy sources, and mains energy source.

### Activating the Second Primary Energy Source in Case of Decrease or Cut-Off of the First Primary Energy Source Defined or Determined by the User 200

While the system receives the electrical energy from the first primary energy source, it is ensured that the second primary energy source is activated in the case that the energy from the first primary energy sources decreases or is cut off through the signals or information coming from the inverters. Here, the second primary energy source may be the generator 3, mains energy or battery.

Controlling the System While the Second Primary Energy Source is Active and if Possible, Activating the First Primary Energy Source, if not Ensuring the Energy Continuity with the Second Primary Energy Source 300

In the case that the second primary energy source decreases or is cut off, it is ensured that the first primary energy source is reactivated through the signals or information received from the inverters, if possible, and if it is not possible, the second primary energy source energizes the system. Here, it is not expected that the first primary energy source will activate unless the second primary energy source decreases or is cut off. If the first primary energy source can be activated, that is, if the first primary energy source is at a level to provide energy, it is also possible for the system to return the energy flow to the first primary energy source.

In the Case that the Second Primary Energy Source is Decreased or Cut Off, Activating the Next Appropriate Energy Source 400

In the case that the second primary energy source is decreased or cut off, it is ensured that the next appropriate energy source is activated. As stated in the previous stage, it should not be forgotten that before the next primary energy source is activated, it is checked whether it is possible to activate the first primary energy source. The next primary energy source may be the generator 3 or the battery 7.

Controlling the System while the next Primary Energy Source is Active and if Possible, Activating the First Primary Energy Source, if not, Ensuring the Energy Continuity with the Second Primary Energy Source and Activating the Next Energy Source or Battery if the Second Primary Energy Source is not Possible 500

It should be noted that this stage is a control stage. Here, when the next primary energy source is active, it is ensured that the system is controlled and the first primary energy source is activated if it is possible, otherwise the energy continuity is provided by the second primary energy source, if the second primary energy source is not possible, the next primary energy source or battery is activated.

### Controlling the System While the Next Primary Energy Source is Active and Providing the Uninterrupted Energy to the System by Activating the Most Appropriate Energy Source 600

While the next primary energy source is active in the system, it is possible to control the system by the inverters and to provide the uninterrupted energy by activating the most appropriate energy source. Here, the most appropriate energy source is the energy sources such as the first primary energy, the second primary energy the next primary energy. The last primary energy source will preferably be the battery 7.

The hybrid power cube 1 of the invention takes the energy from the most appropriate place and supplies the energy to the energy consumption center 6 without interruption, thanks to the inverters 8 containing the software it has. For this reason, the system can also be described as an “intelligent energy management” or “intelligent” hybrid power cube.

### INDUSTRIAL APPLICABILITY OF THE INVENTION

The hybrid power cube of the invention is a device that can be used in many fields. It is an invention that can be used in industry, factories, hospitals, military projects, field services where micro-mains is needed, mixed life projects, etc., in every field where energy is needed. Based on its intended use, the hybrid power cube is the key element of a micro mains. It offers important solutions to the user with its wide possibilities in the electricity generation. The hybrid power cube minimizes the transition time, especially in the energy transition processes that pose a serious problem in the fields where the generators are used and the users will be able to receive the uninterrupted energy without feeling this process and without experiencing financial losses.

The hybrid power cube of the invention can be put on the market as a package, or it can be put on the market without batteries, in connection with a separate battery group. As the application area can range from small energy providers to large power plants, their sizes can be very different.

1. A hybrid power cube comprising at least one inverter and an analyzer which are connected to at least one solar energy source or other alternative energy sources, at least one generator, at least one mains energy and a battery, receives the electrical energy from said solar energy source and/or other alternative energy sources, the generator, the mains energy and the battery according to the determined conditions, transmits the continuous and uninterrupted energy to an energy consumption center and contains energy optimization software.

2. A hybrid power cube according to claim 1, wherein elements which provide the hybrid power cube with energy are the solar energy source and/or other alternative energy sources, the generator, the mains energy, and the battery.

3. A hybrid power cube according to claim 1, wherein instead of the solar energy source, the wind energy source or other alternative energy sources can be used as an alternative to each other or together.

4. A hybrid power cube according to claim 1, wherein the battery is a device used to store the energy in the case that the solar energy source and other energy sources used to provide the system with the energy as well as used in the system are sufficient.

5. A hybrid power cube according to claim 1, wherein the at least one inverter in the hybrid power cube is an energy converter and planner which includes the software.

6. A hybrid power cube according to claim 1, wherein the at least one inverter, comprises multiple inverters connected to each other to work synchronously.

7. A hybrid power cube according to claim 1, further comprising a PLC system integrated into the system and containing the embedded software or a computer system containing at least one processor can be used to provide the energy optimization.

8. A hybrid power cube according to claim 1, wherein the hybrid power cube includes a main accumulator braker.

9. A hybrid power cube according to claim 1, comprising a mains input socket to which the mains energy is connected, a generator input socket to which the energy taken from the generator is connected, a solar energy positive input to which the solar energy source is connected, and a solar energy negative input.

10. A hybrid power cube according to claim 1, further comprising a hybrid inverter in the case that the excess energy produced is transmitted to the mains or other energy consumption centers, and it comprises the inputs-outputs and fuses to transmit said excess energy to the mains or other energy consumption centers, and a counter for the energy measurement.

11. A hybrid power cube according to claim 1, comprising a mains input fuse in the mains input and a generator input fuse at the generator input.

12. A hybrid power cube according to claim 1, comprising a main power output socket—3 phase, main power output—1 phase, power output fuse—3 phase, and power output fuse—1 phase which are connected to the energy consumption center.

13. A hybrid power cube according to claim 1, wherein the hybrid power cube includes a 1-phase output, if desired, or only 3-phase output.

14. A hybrid power cube according to claim 1, comprising a generator start socket connected to the generator and comprises the generator transfer panel to activate the system automatically.

15. A hybrid power cube according to claim 1, comprising at least one front cover that allows the connections or adjustments to be made, at least one fan group for cooling, and at least one monitoring window which allows observing the inside of the cube or the indicators from the outside.

16. A method of running a software included in said inverter providing the continuous and uninterrupted energy between the energy sources connected to the hybrid power cube of claim 1, including said inverter and the energy consumption center providing said hybrid power cube with the energy, wherein the method of running said software comprises technically the steps of:
making all connections (100);
activating the second primary energy source in case of decrease or cut-off of the first primary energy source defined or determined by the user (200);
controlling the system while the second primary energy source is active and, if possible, activating the first primary energy source, if not, ensuring the energy continuity with the second primary energy source (300);
in the case that the second primary energy source is decreased or cut off, activating the next appropriate energy source (400);
controlling the system while the next primary energy source is active and if possible, activating the first primary energy source, if not, ensuring the energy continuity with the second primary energy source and activating the next energy source or battery if the activation of the second primary energy source is not possible (500); and
controlling the system while the next primary energy source is active and providing the system with the uninterrupted energy by activating the most appropriate energy source (600).

17. A method according to claim 16, comprising the steps of connecting the hybrid power cube to all alternative energy sources, the generator and mains in the step of making all connections (100), and ensuring that the system starts working such that it receives the electrical energy from the first primary energy source.

18. A method according to claim 16, comprising the step of activating the second primary energy source in case of decrease or cut-off of the energy from the first primary energy sources through the signal or information from the inverters while receiving the electrical energy from the first primary energy source of the system in the step of activating the second primary energy source in case of decrease or cut-off of the first primary energy source defined or determined by the user (200).

19. A method according to claim 16, wherein in the case that the second primary energy source is decreased or cut off, it comprises the step of reactivating the first primary energy source through the signals or information received from the inverters, if possible, and if it is not possible, ensuring that the second primary energy source energizes the system in the steps of controlling the system while the second primary energy source is active and if possible, activating the first primary energy source, if not, ensuring the energy continuity with the second primary energy source (300).

20. A method according to claim 16, comprising the step of eliminating waiting for the first primary energy source to activate before the second primary energy source decreases or is cut off and converting the energy flow into the first primary energy source in the system if the first primary energy source can be activated.

21. A method according to claim 16, wherein in the case that the second primary energy source is decreased or cut off, it comprises the step of activating the next primary energy source in the step of activating the next appropriate energy source in the case that the second primary energy source is decreased or cut off (400).

22. A method according to claim 16, comprising the step of controlling the system while the next primary energy source is active and if possible, activating the first primary energy source, if not, ensuring the energy continuity with the second primary energy source and activating the next energy source or battery if the activation of the second primary energy source is not possible (500).

23. A method according to claim 16, comprising the steps of controlling the system by the inverters while the next primary energy source is active in the system and providing the uninterrupted energy by activating the most appropriate energy source in the step of controlling the system while the next primary energy source is active and providing the uninterrupted energy by activating the most appropriate energy source (600).

24. A method according to claim 16, wherein the last primary energy source is preferably the battery.
